(19) United States
(12) Patent Application Publication
(10) Pub. No.: US 2008/0232476 A1
(43) Pub. Date: Sep. 25, 2008

(54) Method For Coding/Decoding Video Data

(75) Inventors: Byeong Moon Jeon, Seoul (KR); Seung Wook Park, Seoul (KR); Ji Ho Park, Seoul (KR); Doe Hyun Yoon, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/914,709

(22) PCT Filed: May 19, 2006
(86) PCT No.: PCT/KR2006/001882

§ 371 Date: May 19, 2008

(30) Foreign Application Priority Data
May 18, 2006 (KR) 10-2006-0044779
May 19, 2006 (KR) PCT/KR2006/001882

(51) Int. Cl. H04N 7/26

(52) U.S. Cl. 375/240.24; 375/E07.026

(57) ABSTRACT

The present invention relates to coding of SNR enhancement layer data produced during video signal encoding. The present method determines order or blocks in a picture according to a probability table that is obtained from frequencies of locations where non-zero data exists, scans and codes data on each block to data stream as selecting blocks in the determined order, updates the probability table, re-determines order of blocks in the picture based on the updated probability table, and scans and codes data on each block to data stream just after location where the previous scanning is suspended as selecting blocks in the re-determined order. The present invention increases probability to provide a decoding side with more data that contributes to video quality improvement.

### 1. TECHNICAL FIELD

The present invention relates to a technology for coding video signals according to an SNR-scalable scheme and a technology for decoding such coded video signals.

### 2. BACKGROUND ART

Scalable Video Codec (SVC) is a scheme which encodes video into a sequence of pictures with the highest image quality while ensuring that part of the encoded picture sequence (specifically, a partial sequence of frames intermittently selected from the total sequence of frames) can be decoded and used to represent the video with a low image quality.

An apparatus for encoding data according to a scalable scheme performs transform coding such as Discrete Cosine Transform (DCT) and quantization on data, encoded by motion estimation and prediction operations, in each frame of a received video signal. The quantization causes an information loss. Thus, as shown in FIG. 1a, the encoding apparatus performs inverse quantization 11 and inverse transform 12 to obtain a difference (data for compensating for errors occurring during encoding) from the encoded data, and divides the difference into levels and produces SNR enhancement layer data D10. The SNR enhancement layer data is provided such that the image quality can be gradually improved by increasing the decoding level of the SNR enhancement layer data, which is referred to as Fine Grained Scalability (FGS). In FIG. 1a, an FGS coder 13 in the encoding apparatus performs coding of SNR enhancement layer data for conversion into a data stream. This process is illustrated in FIG. 1b. A data value “1” illustrated in FIG. 1b is not a real data value but a simplified value of any nonzero DCTed coefficient. This simplified value is also used to represent any nonzero data value in blocks in the following description.

The following is a brief description of the process illustrated in FIG. 1b. The FGS coder 13 divides SNR enhancement layer data included in a picture into 4×4 blocks. Then, while selecting blocks 0, 1, 2, . . . sequentially (i.e., in a raster scanning order), the FGS coder 13 sequentially reads data values along a predetermined zigzag scanning path 101 until “1” is read and sequentially arranges the read data values as denoted by “102₁”, thereby finishing a first cycle. Then, while selecting the blocks in the raster scanning order, the FGS coder 13 sequentially scans and reads data values along the zigzag scanning path 101, starting from a position on the scanning path 101 subsequent to a position at which the first cycle was finished in each of the blocks, until “1” is read, and sequentially arranges the read data values as denoted by “102₂”, thereby finishing a second cycle. The FGS coder 13 performs coding in the same manner until all data values in the current picture are coded and arranges the data values in the order of cycles to generate a final data stream 110.

In the above coding method, data coded ahead in the order of cycles is transmitted ahead. However, a stream containing SNR enhancement layer data (hereinafter referred to as FGS data for short) may be cut during transmission as denoted by “111” if the transmission channel bandwidth is reduced. Since data values “1” contribute to improving the image quality more than data values “0”, transmitting as many data values “1” as possible ahead of data values “0” is advantageous to the decoder to improve the image quality on a probabilistic basis when the SNR enhancement layer data transmission is interrupted for a short time due to changes in the transmission channel.

### 3. DISCLOSURE OF THE INVENTION

Therefore, it is an object of the present invention to provide a method for coding data into a stream such that data, which is effective in improving the image quality, is arranged ahead in the stream.

It is another object of the present invention to provide a method for adaptively coding data into a stream such that data, which is effective in improving the image quality, is arranged ahead in the stream.

It is another object of the present invention to provide a method for decoding FGS data coded using the above coding methods.

In a method for coding data according to the present invention, the order of blocks in a picture is set according to a probability table and the blocks are scanned and coded into a data stream while the blocks are sequentially selected in the set order, and thereafter the probability table is updated and the order of blocks in the picture is reset based on the updated probability table and then the blocks, subsequent to a position in each of the blocks at which previous scanning was suspended, are scanned and coded into a data stream while the blocks are sequentially selected in the reset order.

In another method for coding data according to the present invention, a picture is divided into upper-level blocks and the order of the upper-level blocks and the order of blocks in each of the upper-level blocks are set according to a probability table, and then the upper-level blocks and the blocks in each of the upper-level blocks are scanned and coded into a data stream while the upper-level blocks are sequentially selected in the set order thereof and the blocks in each of the selected upper-level blocks are sequentially selected in the set order thereof.

In another method for coding data according to the present invention, a probability table is created based on respective frequencies of positions at which scanning was suspended in each of blocks in a picture, and each of the blocks is coded into a data stream while each of the blocks is scanned along a path determined based on an order of the positions arranged in decreasing order of the frequencies in the created probability table.

In a method for decoding a data stream according to the present invention, the order of blocks and/or upper-level blocks for constructing a picture, which is to be constructed from a received data stream, is determined according to a probability table created according to each of the above coding methods, and the blocks are selected in the determined order and data sections of the data stream are filled in the selected blocks.

In an embodiment of the present invention, the probability table represents a distribution of positions, at which nonzero data is present, in each of the blocks.

In an embodiment of the present invention, the probability table is updated by adding respective frequencies of positions, at which scanning was suspended in a data coding process or data filling was suspended in a data decoding process, in each of the blocks.

In an embodiment of the present invention, the probability table includes a plurality of probability tables classified according to types of blocks and a probability table suitable for a type of blocks to be coded or blocks, in which data is to be filled, is selected and used to determine the order of the blocks of the type.

In an embodiment of the present invention, the order of the upper-level blocks is determined based on an order of respective representative values of the upper-level blocks, the representative value of each of the upper-level blocks being a representative value of positions at which scanning was suspended or data filling was suspended in blocks in the upper-level block, the order of the respective representative values being an order of the respective representative values arranged in a currently used probability table.

In an embodiment of the present invention, the representative value is the average of index values of the positions at which scanning was suspended or data filling was suspended in the blocks.

In an embodiment of the present invention, the representative value is at least one of the sum of index values of the positions at which scanning was suspended or data filling was suspended in the blocks, the minimum thereof, and an integer that is greater than the average by less than one.

In an embodiment of the present invention, the order of the blocks in each of the upper-level blocks or the order of the upper-level blocks is determined according to an order of positions on a scanning path or a filling path immediately subsequent to the positions at which scanning was suspended or data filling was suspended or virtual positions corresponding to the representative values of the upper-level blocks, the order of the immediately subsequent positions being an order of the immediately subsequent positions arranged in the probability table.

In an embodiment of the present invention, each of the upper-level blocks has a size of 16×16 and each of the blocks in each of the upper-level blocks has a size of 4×4.

### 4. BRIEF DESCRIPTION OF THE DRAWINGS

FIG. 1a schematically illustrates an apparatus for encoding video signals when it is applied to FGS (Fine Grained Scalability) data coding;

FIG. 1b schematically illustrates a method for coding FGS data into a data stream;

FIG. 2a schematically illustrates an apparatus for encoding video signals according to the present invention when it is applied to FGS data coding;

FIG. 2b schematically illustrates an example method of the apparatus of FIG. 2a coding FGS data into a data stream;

FIG. 3 schematically illustrates an example of a method for coding FGS data into a data stream while selecting blocks in a different order in each scanning cycle according to an embodiment of the present invention;

FIG. 4 schematically illustrates an example of a method for coding FGS data into a data stream in which the order of blocks to be selected is determined using different probability tables for different types of blocks according to another embodiment of the present invention;

FIG. 5 schematically illustrates a method for determining a scanning path on a block based on a probability table according to an embodiment of the present invention;

FIGS. 6 and 7 schematically illustrate examples of a coding method according to another embodiment in which a picture is divided into macroblocks, the order in which macroblocks are selected is determined based on a probability table, and the order in which blocks in each macroblock are selected is also determined based on the probability table; and

FIG. 8 schematically illustrates the configuration of an apparatus for decoding a data stream encoded by the apparatus of FIG. 2a.

### 5. BEST MODE FOR CARRYING OUT THE INVENTION

Embodiments of the present invention will now be described with reference to the accompanying drawings.

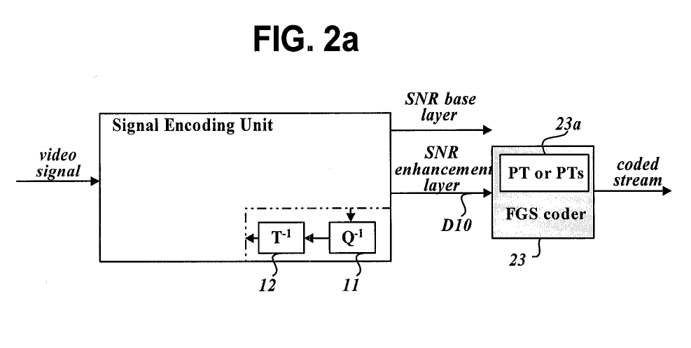

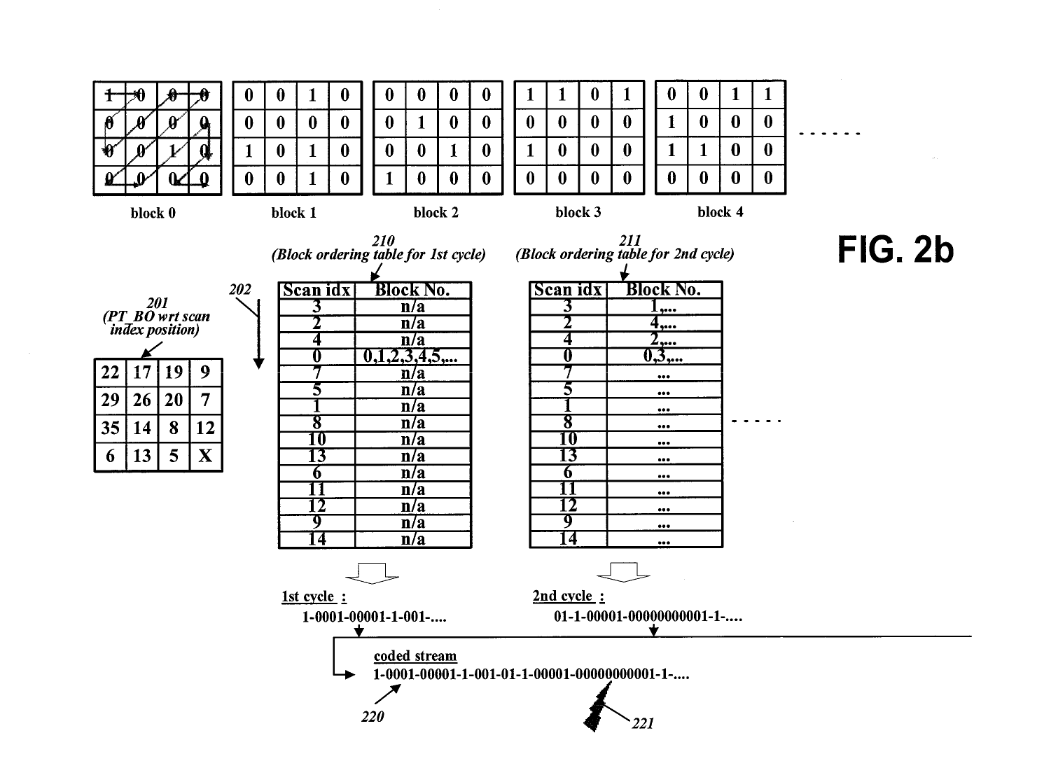

FIG. 2a illustrates the configuration of an encoding apparatus that performs a coding method according to the present invention. The encoding apparatus includes an FGS coder 23 to perform the coding method according to the present invention. In order to perform the coding method according to the present invention, the FGS coder 23 includes a storage 23a (for example, a memory) for storing a probability table based on scan indices of positions in each block, which will be referred to as “a probability table” for short. Although encoded SNR base layer data is also subjected to a coding process suitable for transmitting a data stream as shown in FIG. 2, a description and illustration of this process is omitted since it is not directly related to the present invention.

FIG. 2b schematically illustrates an FGS data coding method according to an embodiment of the present invention, which will be referred to as “FGS coding” for short. In this embodiment, each picture, which may include a frame or slice, is divided into 4×4 sub-blocks to be coded into a data stream.

To perform the method illustrated in FIG. 2b, the FGS coder 23 creates a probability table 201, in which respective frequencies of presence of data “1” (i.e., nonzero data) at positions in each sub-block of an immediately previous picture (or previous pictures) are written, and stores the probability table 201 in the memory 23a before performing FGS coding on a current picture. The FGS coder 23 also creates a block ordering table used to determine a block order in which sub-blocks in the current picture are selected. Specifically, the FGS coder 23 creates a block ordering table by arranging respective scan indices of positions in each sub-block in decreasing order of the frequencies of presence of data “1” at the positions as denoted by “202” with reference to the created probability table 201 and then by writing, in association with each of the scan indices, respective block numbers of one or more sub-blocks, if any, in which scanning was suspended at one or more positions corresponding to the scan index in the previous scanning cycle, and stores the created block ordering table in the memory 23a.

In a block ordering table 210 created for the first cycle, all block numbers are written in association with the first scan index (index 0) as shown in FIG. 2b since there is no cycle prior to the first cycle. When the block ordering table has been created, the FGS coder 23 performs FGS coding of the so first cycle while selecting the sub-blocks in a block order specified in the block ordering table 210 as denoted by “202”. Of course, in the first cycle, the FGS coder 23 codes data in each of the sub-blocks in a zigzag fashion while selecting the sub-blocks in a predetermined order (i.e., in the raster scanning order) since all the sub-blocks are associated with the index value “0” in the first cycle.

Once the first cycle is completed, the FGS coder 23 updates the block ordering table in the memory 23a. Specifically, after the first cycle, the FGS coder 23 creates a block ordering table 211 for the second cycle by writing, in association with each of the scan indices, respective block numbers of one or more sub-blocks in which scanning was suspended at one or more positions corresponding to the scan index in the first cycle. In the example of FIG. 2b, the respective block numbers of the first and fourth sub-blocks (block 0 and block 3) are written in association with the scan index 0 since scanning was suspended at a position corresponding to the scan index 0 in each of the first and fourth sub-blocks (block 0 and block 3), and the block number of the second sub-block (block 1) is written in association with the scan index 3 since scanning was suspended at a position corresponding to the scan index 3 in the second sub-block (block 1).

As the block ordering table 211 for the second cycle is completed, the FGS coder 23 selects the sub-blocks in a block order specified in the block ordering table 211 and reads and codes data at positions in each of the selected sub-blocks while scanning the positions therein, subsequent to a position at which scanning was suspended in the first cycle.

The FGS coder 23 completes a data stream 220 of the current picture by performing the above process for the whole of the current picture. The FGS coder 23 updates the previously created probability table 201 or recreates a probability table and then uses it for a next picture. Although the coded data stream 220 is thereafter compressed according to a suitable encoding scheme, a description of the compression is omitted herein since it is not directly related to the present invention.

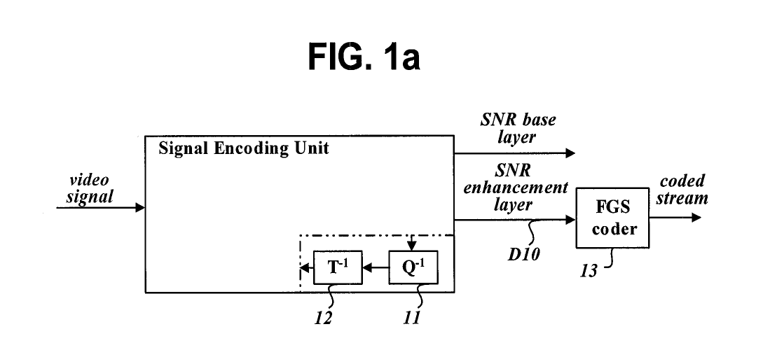

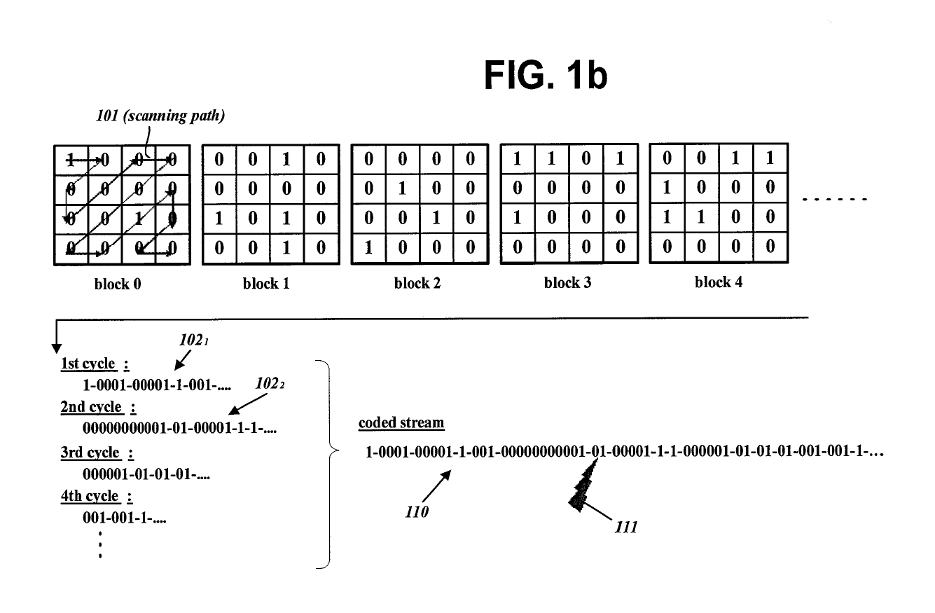

When data is coded according to the FGS coding method of the embodiment of FIG. 2b, there is a high probability that data “1”, which contributes to improving the image quality, is located ahead in the coded data stream. For example, as illustrated in FIG. 2b, even if the coded stream 220 is cut during transmission as denoted by “221”, a larger number of data values “1” than that when using the coding method of FIG. 1b can be transmitted to the decoder. Specifically, 8 data values “1” can be transmitted in the example of FIG. 2b whereas 6 data values “1” can be transmitted in the example of FIG. 1b.

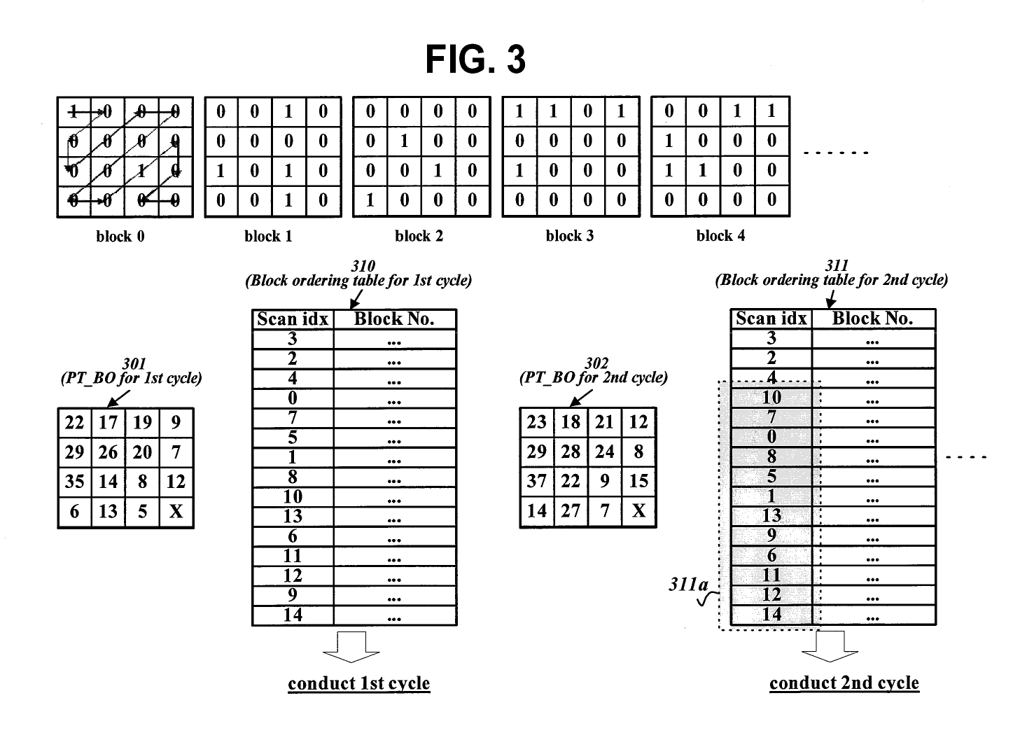

FIG. 3 schematically illustrates an FGS data coding method according to another embodiment of the present invention. In this embodiment, each picture, which may include a frame or slice, is divided into 4×4 sub-blocks to be coded as in the embodiment of FIG. 2b.

In the embodiment of FIG. 3, when performing a first cycle, the FGS coder 23 creates a block ordering table 310 for the first cycle by arranging respective scan indices of positions in each scan-block in decreasing order of the frequencies of suspension of scanning at the positions in a previous picture with reference to a probability table 301 obtained for the previous picture in the same manner as in the embodiment of FIG. 2b. To complete the block ordering table 310, the FGS coder 23 writes respective block numbers of one or more sub-blocks in association with each of the arranged scan indices. To complete the block ordering table for the first cycle, the FGS coder 23 writes the block numbers of all sub-blocks in association with one index (for example, the index 0) as in the embodiment of FIG. 2b. The FGS coder 23 then performs the first cycle while selecting sub-blocks in a block order specified in the block ordering table 310 created for the first cycle.

After finishing the first cycle, the FGS coder 23 updates the probability table 301 in the memory 23a. Specifically, the FGS coder 23 creates a probability table 302 for the second cycle by increasing the frequencies of suspension of scanning of the scan indices in the probability table 301 by the frequencies of suspension of scanning at the corresponding positions in the sub-blocks in the first cycle. The FGS coder 23 then creates a block ordering table 311 for the second cycle based on the created probability table 302. Since the frequencies of positions at which scanning was suspended is changed by performing the first cycle, the order of scan indices of the block ordering table 311 for the second cycle (for example, in a portion 311a thereof in FIG. 3) may differ from that of the block ordering table 301 for the first cycle. Then, the FGS coder 23 completes the block ordering table 311 for the second cycle by writing, in association with each of the scan indices, respective block numbers of one or more sub-blocks in which scanning was suspended at one or more positions corresponding to each of the scan indices in the first cycle. The FGS coder 23 performs FGS coding of data of the second cycle into a data stream while selecting the sub-blocks in the order of corresponding scan indices arranged in the completed block ordering table for the second cycle.

In another embodiment of the present invention, probability tables created for cycles of a previous picture can be used as probability tables for cycles of the current picture. Specifically, when performing FGS coding of a picture, the FGS coder 23 creates respective probability tables for cycles of the picture and stores the created probability tables in the memory 23a. For example, when performing the first cycle of a picture, the FGS coder 23 creates and stores a probability table for the first cycle in which the frequencies of corresponding positions at which scanning was suspended in sub-blocks of the picture in the first cycle are written, and, when performing the second cycle of the picture, the FGS coder 23 creates and stores a probability table for the second cycle in which the frequencies of corresponding positions at which scanning was suspended in the sub-blocks in the second cycle are written. In the same manner, the FGS coder 23 creates and stores a probability table for each of the remaining cycles. Thereafter, when creating a block ordering table of each cycle of a subsequent picture, the FGS coder 23 may determine the order of scan indices based on the stored probability table for the corresponding cycle.

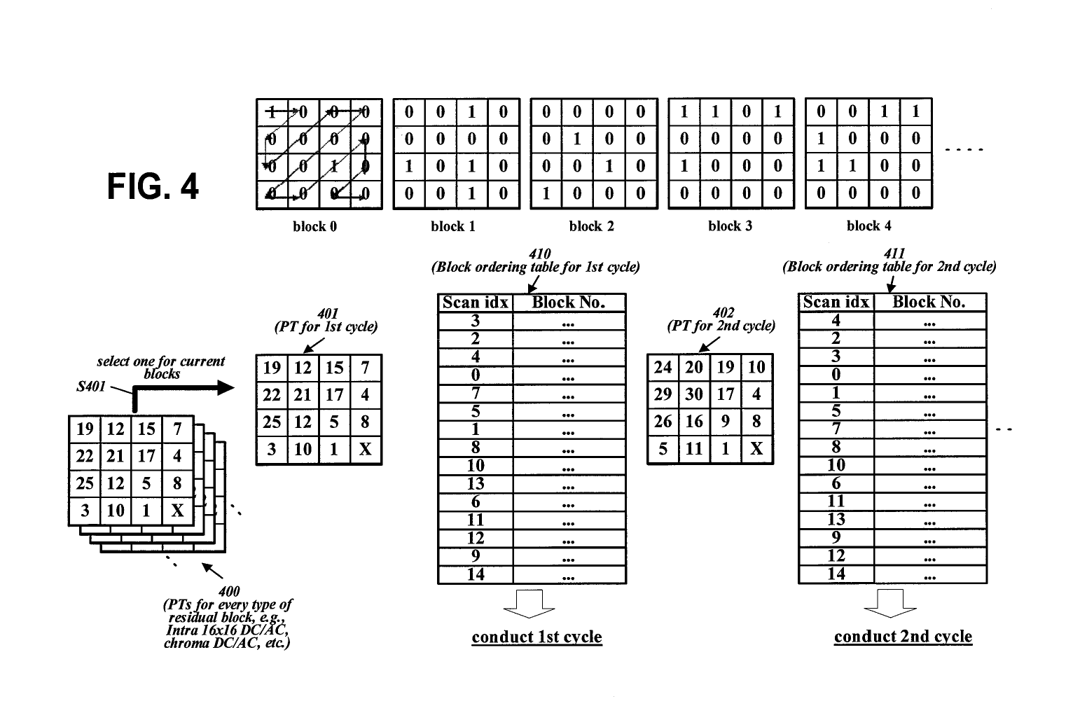

FIG. 4 schematically illustrates an FGS data coding method according to another embodiment of the present invention. In this embodiment, the FGS coder creates and uses a different probability table according to the type of currently coded blocks. For example, the FGS coder creates respective probability tables 400 for 16×16 intra DC or AC blocks, 4×4 inter blocks, and the like. Accordingly, in this embodiment, sub-blocks in a given picture are grouped into different types of groups, each including sub-blocks of the same type, and scans the sub-blocks in the picture on a group-by-group basis.

In this embodiment, the FGS coder 23 selects a probability table according to the type of current blocks grouped in a picture (S401) and creates a block ordering table 410 based on the selected probability table 401. The FGS coder 23 selects blocks in the order of corresponding scan indices arranged in the created table 410 and scans and codes the blocks into a data stream.

When the first cycle is completed, the FGS coder 23 creates a probability table 402 for the second cycle by incorporating, into the probability table, the frequencies of corresponding positions at which scanning was suspended in the first cycle and completes a block ordering table 411 based on the created probability table 402 and then uses the block ordering table 411 in the second cycle.

The FGS coder 23 selects a different probability table for a group of blocks of a different type (S401) and scans and codes the block group into a data stream in the same manner as described above.

In the above embodiments, sub-blocks in a picture are selected in a probability-based order rather than in the raster scanning order, and, when a sub-block is selected, data values in the sub-block are read and coded sequentially along the zigzag scanning path 101. In the following, we describe a method for changing the scanning path in each sub-block on a probabilistic basis according to the present invention rather than using the fixed zigzag path.

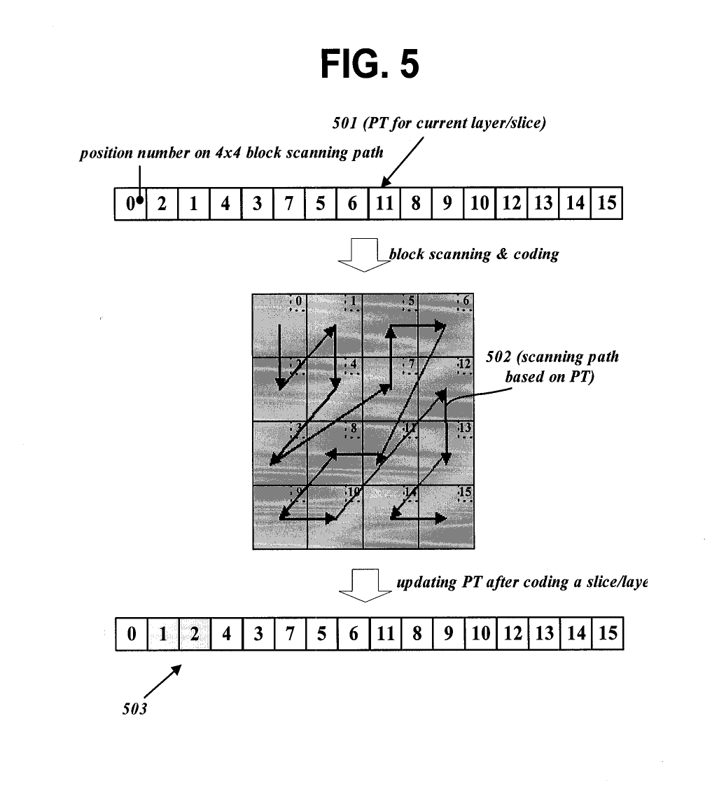

FIG. 5 schematically illustrates a method for determining a scanning path in an FGS data coding method according to an embodiment of the present invention.

Upon completion of FGS coding of a picture, the FGS coder 23 creates a probability table 501 according to the frequency of positions corresponding to each scan index at which data “1” is present in sub-blocks of the picture. The probability table 501 illustrated in FIG. 5 is created by arranging the scan indices in decreasing order of the frequencies. The probability table 501 is created in an example where the largest number of data values “1” are present at positions corresponding to the scan index 0 and the second largest number of data values “1” are present at positions corresponding to the scan index 2.

The probability table 501 created in the above manner is used to determine a scanning path of each sub-block in a next picture. Specifically, the FGS coder 23 reads and codes data of the sub-blocks into a data stream while performing scanning (502) of positions in each of the sub-blocks in the order of corresponding scan indices arranged in the probability table 501. Upon completion of coding of the current picture, the FGS coder 23 updates the created probability table 501 by additionally incorporating, into the probability table, the frequencies of corresponding positions at which data “1” is present in the sub-blocks of the current picture. The updated probability table 503 is used to determine a scanning path of each sub-block of a next picture.

We now describe an FGS data coding method according to another embodiment of the present invention.

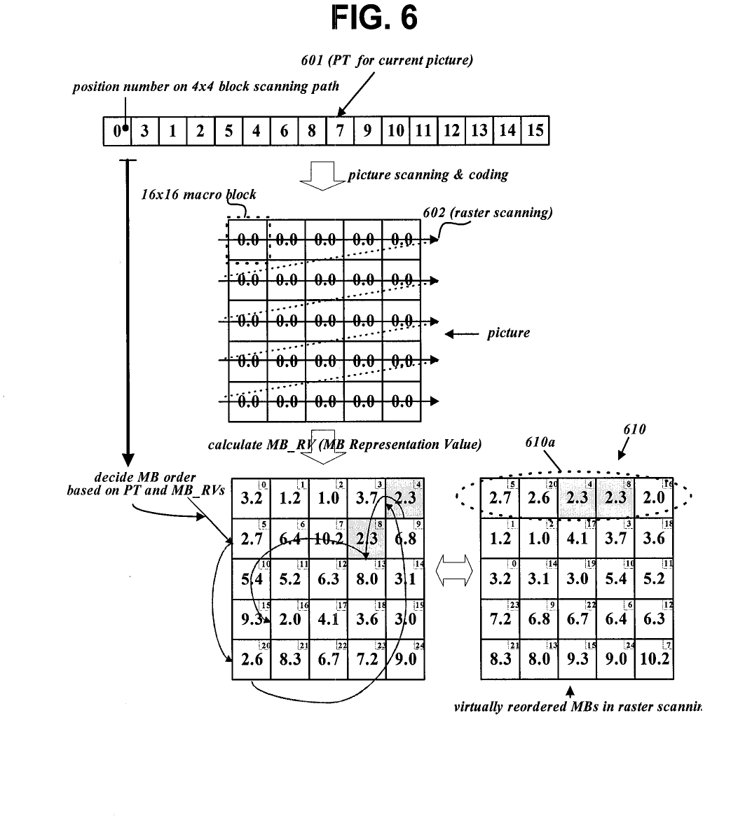

FIGS. 6 and 7 schematically illustrate examples of the FGS data coding method according to this embodiment of the present invention. In this embodiment, each picture is divided into 16×16 macroblocks, and the order in which macroblocks are selected is determined on a probabilistic basis and the order in which 4×4 sub-blocks in each macroblock are selected is also determined on a probabilistic basis.

First, we describe a method for determining the order in which macroblocks are selected. When a picture is given, the FGS coder 23 codes the picture using a probability table 601 of the frequencies of positions at which data “1” is present (i.e., scanning was suspended) in sub-blocks of a previous picture. The FGS coder 23 creates the probability table 601 when coding the previous picture in the same manner as in the above embodiments. When performing the first cycle, the FGS coder 23 codes sub-blocks in each of the macroblocks of the picture while scanning the macroblocks in the raster scanning order (602). The method for determining the order in which the sub-blocks in each macroblock are selected will be described later. After performing the first cycle, the FGS coder 23 determines a representative value of each macroblock. The representative value of each macroblock may be the average of index values of positions at which scanning was suspended in 16 sub-blocks in the macroblock in the first cycle or may be an integer that is greater than the average by less than one. In another embodiment of the present invention, the representative value may be the sum of the index values. In another embodiment, the representative value may be the minimum of the index values.

In the example of FIG. 6, the index value averages of the macroblocks are used as the representative values of the macroblocks and, when the representative values are determined as shown in FIG. 6, the order in which the macroblocks are selected is determined based on the previously created probability table 601 and the representative values of the macroblocks. The method for determining the order of macroblocks will now be described in more detail with reference to the example of FIG. 6. Since the order of indices of the created probability table 601 is 3, 1, 2, . . . (except for 0), the order of macroblocks is determined to be a macroblock having a representative value in the range of 2.0 to 2.9, a macroblock having a representative value in the range of 0 to 0.9, which is not present in the example of FIG. 6, a macroblock having a representative value in the range of 1.0 to 1.9, and so on. The order of blocks having representative values in the same range is determined to be increasing order of the differences of their representative values from the corresponding index value of the probability table as denoted by “610a”. The reason why each index value P is associated with a macroblock having a representative value X in the range of P−1≦X<P, which is less than the index value P, is as follows. If the order of macroblocks is reset based on representative values X so that scanning is initiated from positions corresponding to their index values, each of which is on average less than its associated index P specified in the probability table 601 (P−1≦X<P), there is a high probability that scanning will be suspended at a position corresponding to the index P since scanning was suspended at positions corresponding to the indices specified in the probability table. The same principle that the order of blocks is determined by associating each block having a scanning suspension position index, which is less than a corresponding index specified in the probability table, with the corresponding index is applied when determining the order of sub-blocks in each macroblock, which will be described later in detail.

The picture 610 of FIG. 6 is an example where the order of macroblocks is reset to the raster scanning order in the above manner. The example 610 only illustrates resetting of the order of macroblocks. Indeed, the order in which the macroblocks are selected is reset using identification information of the macroblocks, rather than rearranging the macroblocks. For example, the macroblock selection order is reset using information (5, 20, 4, 8, 16, 1, 2, . . . ) including numbers (written at upper right corners of the macroblocks in the example of FIG. 6) which are assigned to the macroblocks and which are arranged in the order in which the macroblocks are to be selected. When a plurality of macroblocks has the same representative value, the macroblocks are arranged in the raster scanning order. In the example of FIG. 6, a pair of colored (or shaded) macroblocks with identification numbers “4” and “8” written at upper right corners thereof is an example of the plurality of macroblocks having the same representative value.

After the macroblock selection order is reset, the FGS coder 23 performs a second cycle while selecting macroblocks in the reset order and selecting sub-blocks in each macroblock. After performing the second cycle, the FGS coder 23 may update and use the previously created probability table 601 and may also use the same probability table for all cycles of the current picture. The FGS coder 23 uses one of the methods described in the above embodiments when updating the probability table.

After performing the second cycle, the FGS coder 23 updates the representative values of the macroblocks using the frequencies of positions at which scanning was suspended in the sub-blocks in the second cycle and then resets the macroblock selection order based on the updated representative values and the probability table 601 (or the updated probability table). Then, the FGS coder 23 performs a third cycle while selecting the macroblocks in the reset order.

The order in which 4×4 sub-blocks in each macroblock are selected is also determined based on the previously created probability table 601. Specifically, as illustrated in FIG. 7, the FGS coder 23 resets the order of sub-blocks according to the order, in which indices of positions at which scanning was suspended in the sub-blocks are arranged in the probability table 601, at the moment when each cycle is terminated. In the example of FIG. 7, since the index order of the probability table 601 is “0, 3, 1, 2, 5, . . . ”, the FGS coder 23 arranges the sub-blocks in the order of indices “2, 0 (having no corresponding sub-block), 1, 4, . . . ,” of positions at which scanning was suspended in the sub-blocks, which are 1 less than the corresponding indices “3, 1, 2, 5, . . . ” arranged in the probability table 601, respectively (701). If a plurality of sub-blocks having the same scanning suspension position index is present when setting the order of the sub-blocks in the above manner, the FGS coder 23 determines that the order of the plurality of sub-blocks is the raster scanning order (702). In the example of FIG. 7, sub-blocks with identification numbers 1, 5, 7, 9, and 14 written at upper right corners thereof have the same scanning suspension position index (index 2), so that the sub-blocks are arranged in the raster scanning order, i.e., they are arranged in increasing order of their identification numbers 1, 5, 7, 9, and 14. Although the identification numbers are introduced only for illustration in this example, they can also be used as actual identification numbers of sub-blocks.

Upon completion of the arrangement of the sub-blocks, the FGS coder 23 selects the sub-blocks in the arranged order while scanning positions in each of the selected sub-blocks in the current cycle in a zigzag fashion or according to the scanning method of the embodiment of FIG. 5, subsequent to a position therein at which scanning was suspended in the previous cycle, to code data in the sub-blocks into a data stream.

A description will now be given of a method of a decoding apparatus receiving a data stream coded as described above.

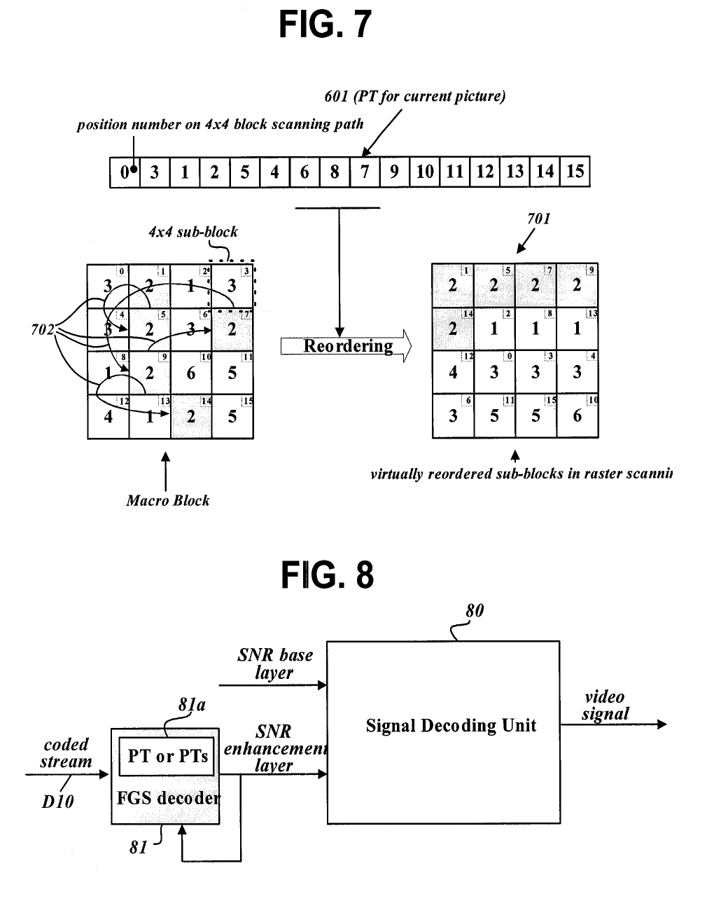

FIG. 8 is a block diagram of an embodiment of an apparatus for decoding a data stream coded and transmitted by the apparatus of FIG. 2a. The data stream received by the apparatus of FIG. 8 contains data decompressed through a suitable decoding process at a front stage. When the apparatus receives an FGS data stream D10 coded using one or more of the methods of FIGS. 2b, 3, 4, 5, 6, and 7, an FGS decoder 81 in the apparatus constructs a first picture by arranging data values “0” or “1” of the data stream in a picture according to the predetermined order in which the first picture has been scanned and coded. Upon completion of the reconstruction of the first picture, the FGS decoder 81 provides the picture data to a signal decoding unit 80 that is provided downstream of the FGS decoder 81 and the signal decoding unit 80 performs inverse quantization and inverse transform on the picture data to decode it into a video signal.

While outputting a picture, the FGS decoder 81 analyzes data in the picture to create a probability table based on the frequencies of positions at which data “1” is present in each sub-block of the picture and stores the created probability table in a storage (for example, a memory 81a). In the case of the embodiment of FIG. 4, the FGS decoder 81 groups sub-blocks in the picture into different types of groups, each including sub-blocks of the same type, and creates different probability tables for the groups.

The FGS decoder 81 then performs the inverse of the coding processes of the above embodiments on subsequent pictures. More specifically, the FGS decoder 81 creates a block ordering table based on the created probability table and stores it in the memory 81a. If the block ordering table is the first created one, block numbers are written in the raster scanning order in association with the index 0 in the block ordering table. Then, the FGS decoder 81 divides the received coded FGS data stream into data sections, each being ended with data “1” (i.e., each having a form of “0 . . . 0001”), selects sub-blocks in an order specified in the block ordering table, and arranges the data sections in the selected sub-blocks along zigzag scanning paths. In the case of the embodiment of FIG. 3, after completing the first cycle, the FGS decoder 81 updates the order of indices of the block ordering table using the frequencies of positions at which data “1” was filled in the sub-blocks in the first cycle.

Before performing the second cycle, the FGS decoder 81 rewrites block numbers in association with the indices in the block ordering table or in the updated block ordering table. Specifically, the FGS decoder 81 writes respective block numbers of one or more sub-blocks in which data “1” was filled at one or more positions corresponding to each of the indices in the first cycle, in association with each of the indices. Upon completion of the block ordering in the block ordering table, the FGS decoder 81 divides the FGS data stream, subsequent to a position therein at which decoding was suspended, into data sections, each being ended with data “1” (i.e., each having a form of “0 . . . 0001”), selects sub-blocks in the block order specified in the block ordering table, and fills the data sections in the selected sub-blocks along zigzag scanning paths. The FGS decoder 81 reconstructs the FGS data stream into a picture in this manner.

In the case of the embodiment of FIG. 4, the FGS decoder 81 creates and uses different block ordering tables for different groups, each including sub-blocks of the same type. The FGS decoder 81 determines the type of a sub-block from a received picture or block header.

In the case of the embodiment of FIG. 5, the FGS decoder 81 does not arrange the divided data sections, each being ended with data “1” (i.e., each having a form of “0 . . . 0001”), along the predetermined zigzag scanning paths as described above and, instead, arranges data of the data sections in the order of position numbers arranged in the created probability table.

In the case of the embodiment of FIGS. 6 and 7, after a portion of the data stream is decoded into data of a picture in a cycle, the FGS decoder 81 determines or updates respective representative values of macroblocks using index values of positions at which decoded data “1” is present in the macroblocks and resets the order of the macroblocks according to positions at which the representative values are arranged in a previously created probability table. This resetting method is the same as that of the coding procedure described with reference to FIGS. 6 and 7.

After setting the order of macroblocks, the FGS decoder 81 rearranges 4×4 sub-blocks in each macroblock according to positions at which indices of positions, at which immediately previously decoded data “1” is present in the sub-blocks, are arranged in a previously created probability table. After the rearrangement, the FGS decoder 81 sequentially selects the macroblocks in a virtual picture in which data is to be filled, sequentially selects the rearranged sub-blocks in each selected macroblock, and sequentially writes data of the divided data sections, each being ended with data “1”, of the input FGS data stream to the selected sub-blocks along zigzag scanning paths (or paths determined according to the embodiment of FIG. 5).

Through these processes, the FGS decoder 81 reconstructs the entire FGS data stream into pictures and transfers the picture data to the decoding unit 80 provided downstream of the FGS decoder 81.

The decoding apparatus described above can be incorporated into a mobile communication terminal, a media player, or the like.

The present invention, which has been described above with reference to the limited embodiments, ensures that there is a high probability that a larger amount of data, which contributes to improving the image quality, than other data is transmitted to the decoder, thereby providing video signals with a higher image quality than the conventional method when the transmission channel changes.

Although the present invention has been described with reference to the preferred embodiments, it will be apparent to those skilled in the art that various improvements, modifications, replacements, and additions can be made without departing from the scope and spirit of the invention. Thus, it is intended that the present invention cover the improvements, modifications, replacements, and additions, provided they come within the scope of the appended claims and their equivalents.

1. A method for coding data, comprising the steps of:
a) setting an order of blocks in a picture according to a probability table and scanning and coding the blocks into a data stream while sequentially selecting the blocks in the set order; and
b) updating the probability table and resetting the order of blocks in the picture based on the updated probability table and then scanning and coding the blocks, subsequent to a position in each of the blocks at which scanning was suspended at the step a), into a data stream while sequentially selecting the blocks in the reset order.

2. The method according to claim 1, wherein the probability table represents a distribution of positions, at which nonzero data is present, in each of the blocks.

3. The method according to claim 2, wherein, at the step b), the probability table is updated by adding respective frequencies of positions, at which scanning was suspended at the step a), in each of the blocks.

4. The method according to claim 2, wherein, at the step b), the order of the blocks is reset according to an order of respective frequencies of positions, at which scanning was suspended at the step a), in each of the blocks in the picture, the order of the respective frequencies being an order of the respective frequencies arranged in the probability table.

5. The method according to claim 1 wherein the probability table includes a plurality of probability tables classified according to types of blocks and, at the steps a) and b), a probability table suitable for a type of blocks to be coded into a current data stream is selected and used to set an order in which the blocks of the type are selected.

6. The method according to claim 1, wherein each of the blocks has a size of 4×4.

7. A method for coding data, comprising the steps of:
a) dividing a picture into upper-level blocks and setting an order of the upper-level blocks and an order of blocks in each of the upper-level blocks according to a probability table; and
b) scanning and coding the upper-level blocks and the blocks in each of the upper-level blocks into a data stream while sequentially selecting the upper-level blocks in the set order thereof and sequentially selecting the blocks in each of the selected upper-level blocks in the set order thereof.

8. The method according to claim 7, wherein, at the step a), the order of the upper-level blocks is determined based on an order of respective representative values of the upper-level blocks, the representative value of each of the upper-level blocks being a representative value of positions at which scanning was suspended in blocks in the upper-level block, the order of the respective representative values being an order of the respective representative values arranged in the probability table, and the order of the blocks in each upper-level block is determined based on an order of positions at which scanning was suspended in the blocks, the order of the positions being an order of the positions arranged in the probability table.

9. The method according to claim 8, wherein the representative value is at least one of the sum of index values of the positions at which scanning was suspended, the average thereof, the minimum thereof, and an integer that is greater than the average by less than one.

10. The method according to claim 8, wherein, at the step a), the order of the blocks in each of the upper-level blocks or the order of the upper-level blocks is determined according to an order of positions on a scanning path immediately subsequent to the positions at which scanning was suspended or virtual positions corresponding to the representative values of the upper-level blocks, the order of the immediately subsequent positions being an order of the immediately subsequent positions arranged in the probability table.

11. The method according to claim 7, wherein each of the upper-level blocks has a size of 16×16 and each of the blocks in each of the upper-level blocks has a size of 4×4.

12. The method according to claim 7, further comprising the step of updating the probability table by incorporating, into the probability table, respective frequencies of positions, at which scanning was suspended at the step b), in each of the blocks of each of the upper-level blocks and resetting the order of the upper-level blocks and the order of the blocks in each of the upper-level blocks based on the updated probability table.

13. A method for coding data, comprising the steps of:
a) creating a probability table based on respective frequencies of positions at which scanning was suspended in each of blocks in a picture; and
b) coding each of the blocks into a data stream while scanning each of the blocks along a path determined based on an order of the positions arranged in decreasing order of the frequencies in the created probability table.

14. The method according to claim 13, further comprising the step of updating the probability table by incorporating, into the probability table, respective frequencies of positions, at which scanning was suspended at the step b), in each of the blocks and resetting the scanning path on each of the blocks based on the updated probability table.

15. The method according to claim 13, wherein each of the blocks has a size of 4×4.

16. A method for decoding a data stream, the method comprising the steps of:
a) setting an order of blocks for constructing a picture according to a probability table, selecting the blocks in the set order, and filling data sections of an input data stream in the selected blocks along a scanning path; and
b) updating the probability table and resetting the order of the blocks for constructing the picture based on the updated probability table and then filling data sections of the data stream in the blocks, subsequent to a position in each of the blocks at which filling was suspended at the step a), while sequentially selecting the blocks in the reset order.

17. The method according to claim 16, wherein the probability table represents a distribution of positions, at which nonzero data is present, in each of the blocks.

18. The method according to claim 17, wherein, at the step b), the probability table is updated by adding respective frequencies of positions, at which filling was suspended at the step a), in each of the blocks.

19. The method according to claim 17, wherein, at the step b), the order of the blocks is reset according to an order of respective frequencies of positions, at which filling was suspended at the step a), in each of the blocks for constructing the picture, the order of the respective frequencies being an order of the respective frequencies arranged in the probability table.

20. The method according to claim 16, wherein the probability table includes a plurality of probability tables classified according to types of blocks and, at the steps a) and b), a probability table suitable for a type of blocks, in which current data is to be filled, is selected and used to set an order in which the blocks of the type are selected.

21. The method according to claim 16, wherein each of the blocks has a size of 4×4.

22. The method according to claim 16, wherein each of the data sections begins with zero data and ends with nonzero data.

23. A method for decoding a data stream, the method comprising the steps of:
a) dividing a picture to be constructed into upper-level blocks and setting an order of the upper-level blocks and an order of blocks to be constructed in each of the upper-level blocks according to a probability table; and
b) filling data sections of an input data stream in the blocks along a scanning path while sequentially selecting the upper-level blocks in the set order thereof and sequentially selecting the blocks in each of the selected upper-level blocks in the set order thereof.

24. The method according to claim 23, wherein, at the step a), the order of the upper-level blocks is determined based on an order of respective representative values of the upper-level blocks, the representative value of each of the upper-level blocks being a representative value of positions at which filling was suspended in blocks in the upper-level block, the order of the respective representative values being an order of the respective representative values arranged in the probability table, and the order of the blocks in each upper-level block is determined based on an order of positions at which filling was suspended in the blocks, the order of the positions being an order of the positions arranged in the probability table.

25. The method according to claim 24, wherein the representative value is at least one of the sum of index values of the positions at which filling was suspended, the average thereof, the minimum thereof, and an integer that is greater than the average by less than one.

26. The method according to claim 24, wherein, at the step a), the order of the blocks in each of the upper-level blocks or the order of the upper-level blocks is determined according to an order of positions on a scanning path immediately subsequent to the positions at which filling was suspended or virtual positions corresponding to the representative values of the upper-level blocks, the order of the immediately subsequent positions being an order of the immediately subsequent positions arranged in the probability table.

27. The method according to claim 23, wherein each of the upper-level blocks has a size of 16×16 and each of the blocks in each of the upper-level blocks has a size of 4×4.

28. The method according to claim 23, further comprising the step of updating the probability table by incorporating, into the probability table, respective frequencies of positions, at which filling was suspended at the step b), in each of the blocks of each of the upper-level blocks and resetting the order of the upper-level blocks and the order of the blocks in each of the upper-level blocks based on the updated probability table.

29. The method according to claim 23, wherein each of the data sections begins with zero data and ends with nonzero data.

30. A method for decoding a data stream, comprising the steps of:
a) creating a probability table based on respective frequencies of positions at which filling was suspended in each of blocks to be constructed in a picture; and
b) filling data sections of the data stream in each of the blocks along a path determined based on an order of the positions arranged in decreasing order of the frequencies in the created probability table.

31. The method according to claim 30, further comprising the step of updating the probability table by incorporating, into the probability table, respective frequencies of positions, at which filling was suspended at the step b), in each of the blocks and resetting the filling path on each of the blocks based on the updated probability table.

32. The method according to claim 30, wherein each of the blocks has a size of 4×4.

33. The method according to claim 30, wherein each of the data sections begins with zero data and ends with nonzero data.
